(19) United States
(12) Patent Application Publication
(10) Pub. No.: US 2007/0183415 A1
(43) Pub. Date: Aug. 9, 2007

(54) Method and system for internal data loop back in a high data rate switch

(75) Inventors: Stephen Fischer, Edison, NJ (US); Lampros Kalampoukas, Brick, NJ (US); Anand Kanagala, Edison, NJ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Incorporated, Alameda, CA (US)

(21) Appl. No.: 11/346,671

(22) Filed: Feb. 3, 2006

(51) Int. Cl. H04L 12/56; H04J 3/16

(52) U.S. Cl. 370/389; 370/469

(57) ABSTRACT

A method and system for internal data loop back in a packet switch is provided. In some instances, the switch may be required to process multiple layers of a header within the data packet, such as when data is transferred over the network encapsulated with a TCP header at the Transport Layer to form a TCP packet, then encapsulated with an IP header at the Network Layer to form an IP packet, then encapsulated with one or more MPLS headers to form a MPLS packet, and then encapsulated with an Ethernet header at the Link Layer to form an Ethernet packet. In such an instance, the data packet can be iteratively processed by the packet switch using an internal loop back technique. An internal loop back may be accomplished by using a header providing internal routing instructions resulting in the data packet being routed directly from an egress queue back to an ingress queue whereupon the lower levels of the header can be processed.

### FIELD OF INVENTION

The present invention relates to processing data packets at a packet switch (or router) in a packet switched communications network, and more particularly, to a method of iteratively processing layers of a packet header using an internal loop back within the packet switch so as to reduce complexity and the amount of packet processing resources needed within the packet switch and to increase processing flexibility.

### BACKGROUND

A switch within a data network receives data packets from the network via multiple physical ports, and processes each data packet primarily to determine on which outgoing port the packet should be forwarded. Other actions might also be performed on the packet including replicating the packet to be multicast to multiple outgoing interfaces, sending special or exception packets to a CPU for high-level processing such as updates to a route table, or dropping the packet due to some error condition or filter rule, for example.

In a packet switch, a line card is typically responsible for receiving packets from the network, processing and buffering the packets, and transmitting the packets back to the network. In some packet switches, multiple line cards are present and interconnected via a switch fabric, which can switch packets from one line card to another. On a line card, the direction of packet flow from network ports toward the switch fabric is referred to as “ingress”, and the direction of packet flow from the switch fabric toward the network ports is referred to as “egress”.

In the ingress direction of a typical line card in a packet switch, a packet received from the network is processed by an ingress header processor, stored in external memory by an ingress buffer manager, and then scheduled for transmission across the switch fabric by an ingress traffic manager. In the egress direction, a packet received from the switch fabric at a line card is processed by an egress header processor, stored in external memory by an egress buffer manager, and then scheduled for transmission to a network port by an egress traffic manager.

A data packet comprises data payload encapsulated by one or more headers containing specific information about the packet such as the packet's type, source address and destination address, for example. The multiple headers of a packet come from multiple protocol layers in the network containing physical or link layer information, error checking and correcting information, or destination routing/addressing information, for example. Some data to be transferred over the network may be encapsulated with a TCP (transmission control protocol) header at the Transport Layer to form a TCP packet, then encapsulated with an IP (internet protocol) header at the Network Layer to form an IP packet, then encapsulated with one or more MPLS (multi-protocol label switching) headers to form an MPLS packet, and then encapsulated with an Ethernet header at the Link Layer to form an Ethernet packet.

A packet switch is often required to process multiple layers of header information in a data packet, and in particular, the packet switch may be required to process the header from only one layer for some packets or headers from multiple layers for other packets. This can add complexity and extra resources to the packet processing engines to support the processing of the maximum number of protocol headers to be supported by the packet switch, for example, supporting such operations might require replication of existing resources. Also, since it is usually not known beforehand how many layers of header need to be processed, the ingress packet header processor engine is often sent more bytes of packet header than what the engine usually needs. This can lead to unnecessarily high bandwidth requirements for the ingress packet header processor engine to meet a specified packet processing rate. Note that typically the bandwidth of the ingress packet header processor engine (or the egress packet header processor engine) is usually less than the total bandwidth of the line card so as to reduce complexity and cost of these engines.

In some applications, such as IP multicasting or Ethernet bridging, some packets need to be replicated by the packet switch to be multicast to multiple outgoing interfaces. Such multicasting typically results in added complexity to one or more of the ingress traffic management engine, ingress buffer management engine and switch fabric. Moreover, many multicasting schemes have performance issues where the quality of service of multicast packets destined to a particular interface can be degraded due to a backlog of packets on another interface in the same multicast group.

As a result, reduced complexity packet switches that have the ability to meet today's packet processing needs are desirable.

### SUMMARY

In one embodiment, a packet switch is provided that includes a multiplexer, a processing engine, and a loopback data path. The multiplexer receives data packets at a first input data port and passes them to the processing engine. The processing engine receives the data packet from the multiplexer and processes multiple layers of the data packet. The processing engine prepends a signature header to the data packet including information relating to a destination port of the processing engine corresponding to which the data packet is to be sent. The loopback data path is provided from an output of the processing engine to a second input data port of the multiplexer. Based on the signature header, the processing engine passes the data packet to the loopback data path in order to re-introduce the data packet to the processing engine for additional packet processing.

In another aspect, a method for processing data packets received at a packet switch is provided. The method includes receiving a data packet into a multiplexer of the packet switch and processing the data packet at an input processing engine. The method also includes determining if further data packet processing is required and providing a loopback data path for the data packet to be reintroduced to an input of the multiplexer if further processing is required. The method further includes iteratively processing layers of the data packet at the input processing engine. This allows for packets with arbitrary deep header layers to be processed using the same processing resources that were optimized for processing limited number of header layers.

These and other aspects will become apparent to those of ordinary skill in the art by reading the following detailed description, with reference where appropriate to the accompanying drawings. Further, it should be understood that the embodiments noted herein are not intended to limit the scope of the invention as claimed.

### BRIEF DESCRIPTION OF FIGURES

FIG. 1 is a block diagram illustrating one embodiment of a communication network.

FIG. 2 is a block diagram illustrating one example of a packet switch.

FIG. 3 is a block diagram illustrating a detailed example of the packet switch.

FIG. 4 is a block diagram illustrating one example of a component of the packet switch.

FIG. 5 is a block diagram illustrating another detailed example of the packet switch.

FIG. 6 is a block diagram illustrating yet another detailed example of the packet switch.

### DETAILED DESCRIPTION

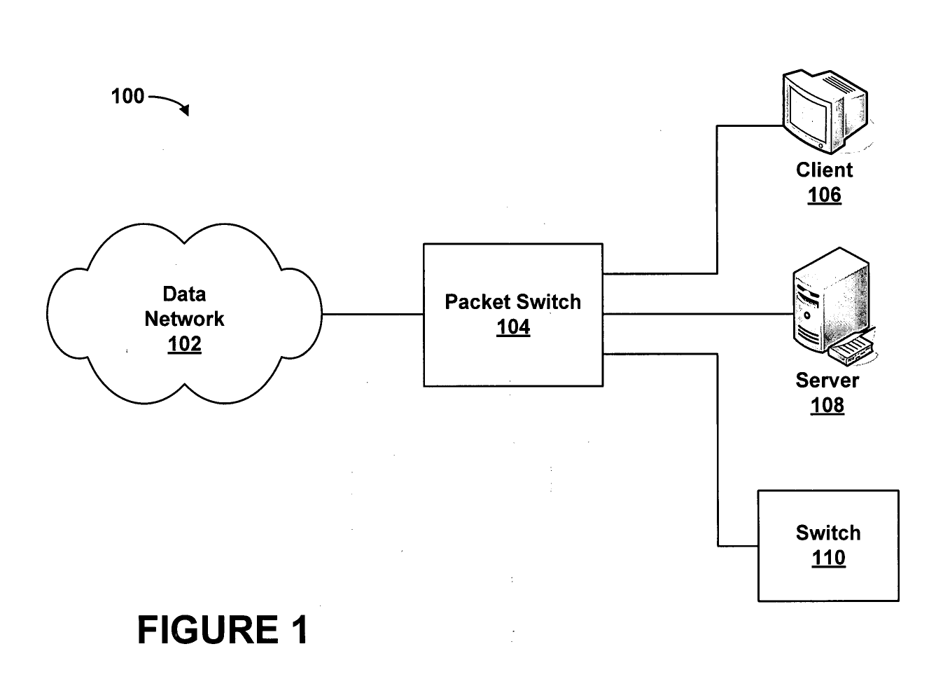

Referring now to the figures, and more particularly to FIG. 1, one embodiment of a communication network 100 is illustrated. It should be understood that the communication network 100 illustrated in FIG. 1 and other arrangements described herein are set forth for purposes of example only, and other arrangements and elements can be used instead and some elements may be omitted altogether, depending on manufacturing and/or consumer preferences.

By way of example, the network 100 includes a data network 102 coupled via a packet switch 104 to a client device 106, a server 108 and a switch 110. The network 100 provides for communication between computers and computing devices, and may be a local area network (LAN), a wide area network (WAN), an Internet Protocol (IP) network or some combination thereof

The packet switch 104 receives data packets from the data network 102 via multiple physical ports, and processes each individual packet to determine to which outgoing port the packet should be forwarded, and thus to which device the packet should be forwarded.

When the aggregate bandwidth of all incoming ports at the packet switch 104 is high, the resources of the packet switch 104 can be optimized to minimize hardware logic, minimize cost and maximize packet processing rate. One optimization of packet switch 104 resources includes limiting the number of bytes that are sent to a packet header processor in the packet switch. For example, if it is known that the packet header processor will only need to process the first 64 bytes of a packet, then only the first 64 bytes of each packet can be sent to that packet header processor. The number of bytes sent to the processor can be further optimized as follows, for example, if the packet header processor is always ignoring a certain number of bytes at the start of the header, then these bytes can be removed by the port interface module prior to sending the header to the processor. As another example, if the packet header processor is performing a destination IP address lookup of an IP packet, then the Ethernet header is not needed by the header processor. The Ethernet header bytes can therefore be stripped from the packet prior to the packet being sent to the header processor.

A further optimization of the number of bytes sent to the processor is accomplished by having some packet types initially identified as requiring less bytes to be processed than other packets. In such a case, a variable number of header bytes can be sent to the header processor with the determination on the amount of header bytes that are sent to the header processor being performed on a packet-by-packet basis. The number of bytes to send to the processor can be determined by the port interface module based on some preliminary packet parsing and identification of the packet type together with configuration information about the port interface type. For example, if a packet is identified as an ARP packet, then it is known that this packet will be forwarded to the CPU, so it is sufficient to only send enough bytes to the processor to identify the packet type as ARP. On the other hand, if a packet is identified as requiring IPv4-level processing, then it is known that the IP header is needed to determine where the packet should be routed, so more bytes need to be sent to the processor than for the ARP packet.

The packet switch 104 supports multiple types of packet services, such as for example Layer 2 bridging, IPv4, IPv6, and MPLS on the same physical port. A port interface module in the packet switch 104 determines how a given packet is to be handled and provides special “handling instructions” to packet processing engines in the packet switch 104. In the egress direction, the port interface module frames outgoing packets based on the type of the link interface. Example cases of the processing performed in the egress direction include: attaching appropriate source and destination media access control (MAC) addresses (for Ethernet interfaces), adding/removing virtual LAN (VLAN) tags, attaching PPP/HDLC header (point to point protocol/high-level data link control for packet over sonet interfaces), and similar processes. In depth packet processing, which includes packet editing, label stacking/unstacking, policing, load balancing, forwarding, packet multicasting, packet classification/filtering and other, occurs at header processor engines in the packet switch.

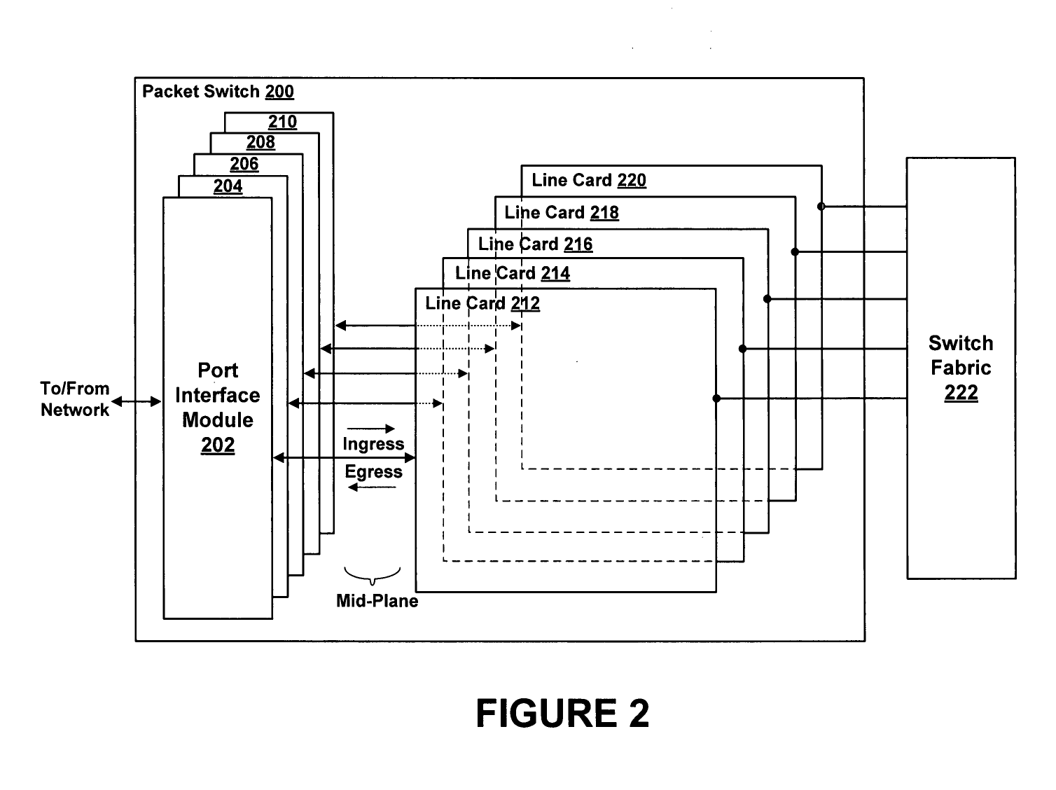

FIG. 2 illustrates a block diagram of one example of a packet switch 200. The packet switch 200 includes port interface modules 202-210 coupled through a mid-plane to packet processing cards or line cards 212-220, which each connect to a switch fabric 222. The packet switch 200 may include any number of port interface modules and any number of line cards depending on a desired operating application of the packet switch 200. The port interface modules 202-210, line cards 212-220 and switch fabric 222 may all be included on one chassis, for example.

Each port interface module 202-210 connects to only one line card 212-220. The line cards 212-220 process and buffer received packets, enforce desired Quality-of-Service (QoS) levels, and transmit the packets back to the network. The line cards 212-220 are interconnected via the switch fabric 222, which can switch packets from one line card to another.

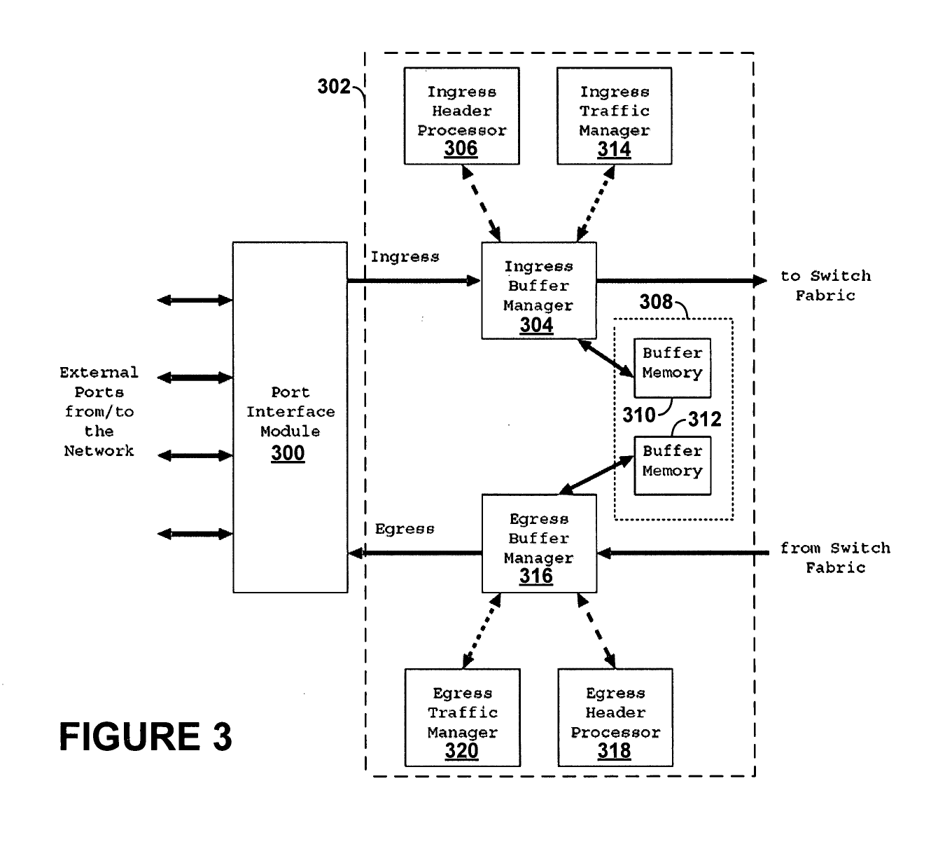

FIG. 3 is a block diagram illustrating a detailed example of the packet switch. In FIG. 3, only one port interface module 300, which is connected to a line card 302, is illustrated.

The line card 302 includes an ingress buffer manager 304, an ingress header processor 306, memory 308 including ingress memory 310 and egress memory 312, an ingress traffic manager 314, an egress buffer manager 316, an egress header processor 318 and an egress traffic manager 320.

The ingress buffer manager 304 receives data from the port interface module 300 and passes some or all of the data to the ingress header processor 306. The ingress header processor 306 processes header information extracted from the packet and passes the processed header information back to the ingress buffer manager 304, which stores the processed and updated header data together with the payload packet data in the buffer memory 310. The ingress header processor 306 determines to which output port the data will be sent, and the QoS operations to be performed on the data, for example. Subsequently, the ingress traffic manager 314 will direct the ingress buffer manager 304 to pass the stored data packets to the switch fabric.

The egress buffer manager 316 will receive data packets from the switch fabric and pass some or all of the packet data to the egress header processor 318. The egress header processor 318 processes header information within the data and passes the processed data back to the egress buffer manager 316, which stores the processed header data with payload packet data in the buffer memory 312. Subsequently, the egress traffic manager 320 will direct the egress buffer manager 316 to pass the stored data packets to the port interface module 300, which in turn, sends the data packets on the outgoing ports to the network.

In some instances, the packet switch may be required to process multiple layers of header in the data packet, for example, some data to be transferred over the network may be encapsulated with a TCP header at the Transport Layer to form a TCP packet, then encapsulated with an IP header at the Network Layer to form an IP packet, then encapsulated with one or more MPLS headers to form a MPLS packet, and then encapsulated with an Ethernet header at the Link Layer to form an Ethernet packet. In such an instance, instead of the packet header processor processing all protocol layers in one pass, the data packet can be iteratively processed by the packet switch using an internal loop back technique. An internal loop back may be accomplished by the ingress or egress header processor modifying bytes in the signature header of the packet to instruct the egress buffer manager to switch the packet directly from the egress queue back to an ingress queue whereupon the lower levels of the header can be processed.

In one embodiment, a loopback path from egress to ingress on a line card of the packet switch is used to re-introduce an egress packet into the ingress pipeline for additional packet processing. Such a mechanism helps to optimize resources needed for packet processing since resources can be re-used by a packet that follows the loopback path as opposed to excessive replication of resources.

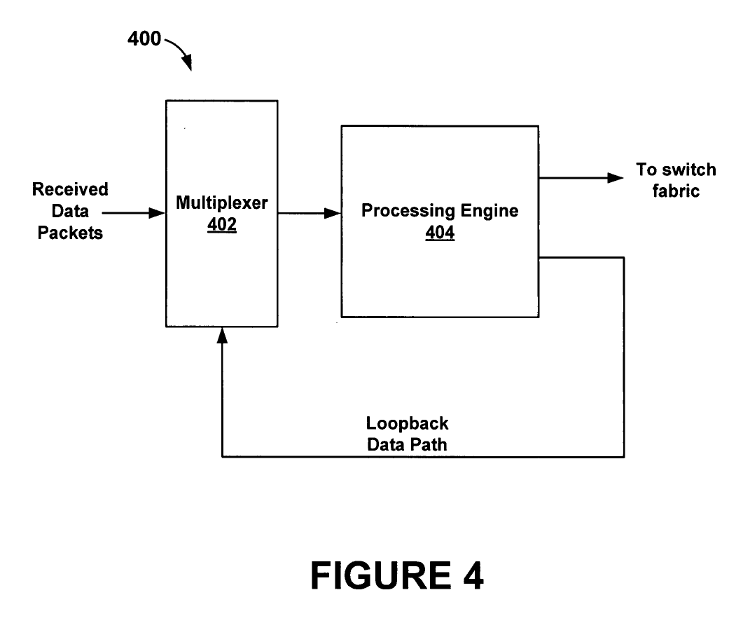

FIG. 4 illustrates a block diagram of one embodiment of a buffer manager 400. The buffer manager 400 receives data packets at a multiplexer 402 and passes them to a processing engine 404. Depending on the processing needed per data packet, the processing engine 404 will either pass the data packet onto the switch fabric to deliver the data packet to its destination, or pass the data packet onto a loopback data path such that the data packet can be subjected to further processing by the processing engine 404.

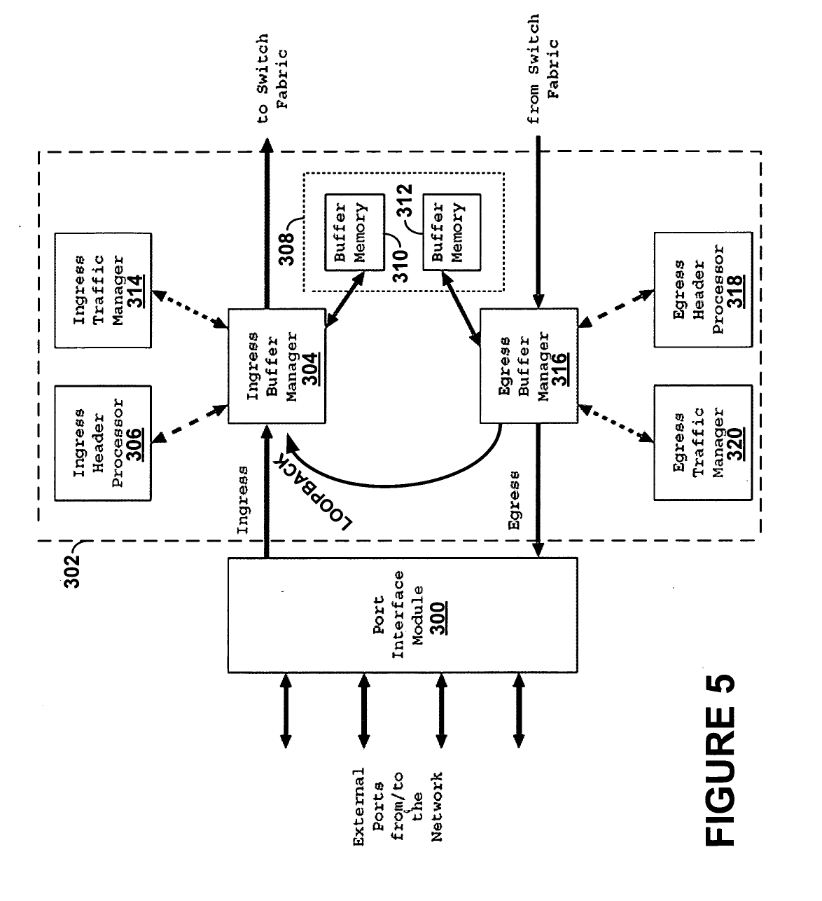

FIG. 5 illustrates a block diagram of one example of the packet switch 302 with separate ingress and egress buffer manager devices and a loopback path from egress to ingress. The ingress buffer manager receives data packets from the port interface module and passes the packet headers to the ingress header processor for processing. The ingress traffic manager then schedules the packets to be sent by the ingress buffer manager to the switch fabric. The egress buffer manager receives data packets from the switch fabric and passes the packet headers to the egress header processor for processing. The egress traffic manager engine then schedules the packets to be sent by the egress buffer manger to the output ports. As a result of processing by the ingress or egress header processor engines, some packets may need to be sent by the egress buffer manager over the loopback path from egress to ingress for further processing by the ingress header processor. The ingress buffer manager engine has a multiplexer at its input to multiplex packets received over the loopback interface with those received from the incoming ports.

In some packet switches, loopback paths may exist both within the ingress buffer manager (as in FIG. 4) and also between the egress and ingress buffer manger engines (as in FIG. 5).

The loopback data path can be used to process packets that require similar types of processing to be performed multiple times in an iterative fashion. For example, a lookup of the destination address from the outermost protocol header of a data packet might result in a decision to unstack this protocol header and do a lookup of the destination address in the next encapsulated protocol header. Then, a lookup of the destination address from the next protocol header might, in turn, result in a decision to unstack another protocol header, and so on. If a particular packet requires more unstacking of headers than what the ingress header processor engine pipeline can support, then the loopback mechanism allows the packet to be sent to egress, then looped back to the ingress header processor engine for further processing, for example.

Furthermore, as a packet is passing through the packet processing stages of the ingress header processor engine, a later processing stage might detect a condition that requires the type of processing supported in earlier stages of the header processor engine. For example, after unstacking multiple layers of protocol header, an encapsulated IP header might be found to have an expired time-to-live (TTL). Such a packet needs to be forwarded to a CPU, for example, but if there are multiple CPUs in the system, the particular CPU to send the packet might need to be determined based on an incoming interface or other information in the packet headers. In such a situation, the loopback mechanism can be used to send the packet back to the ingress header processor engine where a lookup can be done to determine which CPU to forward the packet.

The loopback data path can also be used to open up bandwidth of the ingress header processor engine. For example, to help maximize the packet processing rate of the ingress header processor engine, it is desirable to optimize the amount of header data sent to the ingress header processor engine. The amount of data to be sent to the ingress header processor engine does not need to be the maximum amount to cover the worst possible number of header unstacks, since such cases can be supported using the loopback mechanism. The amount of data sent to the ingress header processor engine can therefore be optimized by sending only the amount of header data required for typical packet processing cases, and if additional processing stages are found to be required, the data packet can be looped back to the ingress header processor engine through the loopback data path. Therefore, the system architecture can be optimized based on the common processing modes, while allowing exception cases to be handled through the loopback mode.

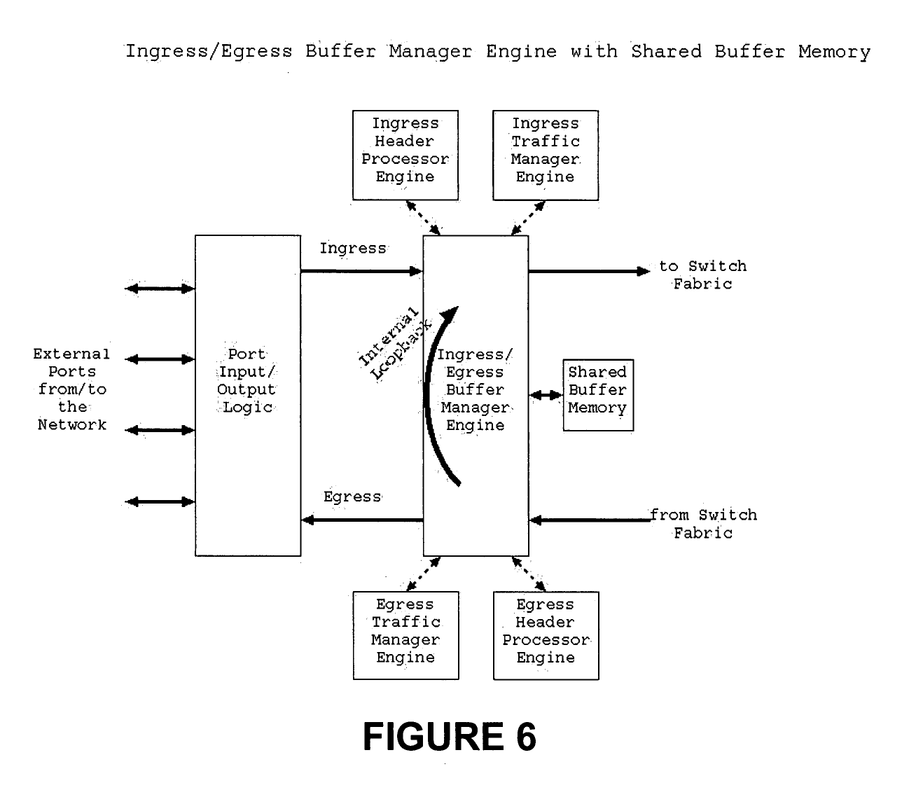

The bandwidth of the loopback data path can be optimized when the ingress buffer engine and egress buffer engine share a common buffer memory for ingress and egress packets, as illustrated in the example packet switch in FIG. 6. In such a situation, it is not necessary to read the entire loopback packet from buffer memory on egress and re-write the packet to buffer memory on ingress. Instead, only the packet header data that is to be sent to the ingress header processor engine need be read from buffer memory. The modified packet header data resulting from processing in the ingress header processor engine is then linked back to the rest of the packet in the buffer memory.

In addition, in some applications, such as IP multicasting or Ethernet bridging, some packets need to be replicated by the packet switch to be multicast to multiple outgoing interfaces. Such multicasting typically requires added complexity in one or more of the ingress traffic management engine, ingress buffer management engine and switch fabric. Moreover, many multicasting techniques have performance issues where the quality of service of multicast packets destined to a particular interface can be degraded due to a backlog of packets on another interface in the same multicast group.

The loopback technique may also provide additional benefits for such application. For example, in multicasting applications, when sending an IP datagram to a set of hosts that form a single multicast group requires to stream data to multiple destinations at the same time, the loopback mechanism allows a packet to be sent to the egress without replication on ingress. The egress header processor engine replicates the packet for each outgoing interface on the particular line card. If the packet needs to be forwarded to one or more interfaces on another line card in the packet switch, then one copy of the packet is sent over the loopback data path to the ingress from where it will be sent to another line card. This multicasting technique does not suffer from performance issues where the quality of service of multicast packets destined to a particular interface can be degraded due to a backlog of packets on another interface in the same multicast group.

As a specific example, consider receiving a data packet including six headers, namely a signature header (SIG), an Ethernet header, two MPLS headers, an IP header and a TCP header. The signature header is the result of packet pre-classification that occurs at a port interface module of the packet switch. For example, the port interface module can prepend some “signature” bytes to the front of a data packet to carry certain information about the packet that may only be relevant within the packet switch. In particular, the packet signature carries information about the packet type, the arriving port number, and the number of bytes to send to the header processor engine, or information concerning the outgoing port determined from a lookup of the packet's destination address, for example.

The ingress header processor engine 306 will initially remove the signature and Ethernet headers, since they are no longer needed. Also, the MPLS headers, which direct a flow of IP packets along a predetermined path across a network, are removed and the data packet is then processed based on Layer 3 information such as the IP destination address. An address lookup will need to be performed based on the IP header, but in order to maintain a high data packet processing and forwarding rate and deliver bounded processing latency for packets going through the system that require typical processing, this data packet may need to be passed through the header processor engine so that the next packet can be received and processed. Thus, rather than holding up the processing of future data packets, this packet can be further processed by passing it back to an input of the ingress buffer manager engine to be re-sent to the ingress header processor engine. To do so, the ingress header processor engine can modify the signature header to have an egress destination port be that of the loopback data path, and prepend the signature header back to the data packet. In this manner, the data packet will be passed back to the multiplexer at the input of the ingress buffer manager engine and, in turn, received by the ingress header processor engine for further processing of the IP packet header.

As another example, if after unstacking the MPLS label twice, the IP header is reached and a TTL (time-to-live) of the data packet is expired, the data packet will need to be sent to the CPU so the CPU can inform the source that the packet has expired. In this instance, the data packet can be output on the loopback data path so that the next time the ingress header processor engine receives the data packet, the ingress header processor engine will recognize that the TTL has expired and a lookup is performed to determine to send the data packet to the CPU. Other types of exception traffic may also be processed and sent to the system CPU in a similar manner.

In the examples above, a decision is made whether to send a packet over the loopback path by the egress buffer manager based on information contained in the internal signature header of the packet. Information about where to send the packet is inserted by either the ingress or egress header processors. For example, the ingress header processor might decide that the packet needs to be sent over the loopback path because the packet has reached the end of a processing pipeline in the header processor (e.g., end of resources), but the packet still needs further processing, for example, if the TTL has expired or to unstack multiple protocol headers.

It should be understood that the processes, methods and networks described herein are not related or limited to any particular type of software or hardware, unless indicated otherwise. For example, operations of the packet switch may be performed through application software, hardware, or both hardware and software. In view of the wide variety of embodiments to which the principles of the present embodiments can be applied, it is intended that the foregoing detailed description be regarded as illustrative rather than limiting, and it is intended to be understood that the following claims including all equivalents define the scope of the invention.

What is claimed is:

1. A packet switch comprising:
a multiplexer for receiving data packets at a first input data port;
a processing engine for receiving a data packet from the multiplexer and for processing multiple layers of the data packet, wherein the processing engine prepends a signature header to the data packet including information relating to a destination port of the processing engine corresponding to which the data packet is to be sent; and
a loopback data path from an output of the processing engine to a second input data port of the multiplexer, wherein based on the signature header, the processing engine passes the data packet to the loopback data path in order to re-introduce the data packet to the processing engine for additional packet processing.

2. The packet switch of claim 1, wherein the multiplexer receives data packets from the loopback data path at the second input data port and multiplexes the data packets with the data packets received at the first input data port so as to pass data packets received at the first input data port and the second input data port to the processing engine in a round-robin format.

3. The packet switch of claim 1, wherein the processing engine modifies information in the signature header of the data packet if additional processing of the data packet is necessary to send the data packet back to the processing engine over the loopback path.

4. The packet switch of claim 1, wherein the processing engine modifies information in the signature header of the data packet if a TTL (time to live) component of the data packet has expired to send the data packet back to the processing engine over the loopback path for further processing.

5. The packet switch of claim 1, wherein data packets are sent over the loopback data path in order to iteratively process the data packets.

6. A packet switch comprising:
an ingress buffer manager for receiving and buffering data packets;
an ingress header processor for receiving packet headers of the data packets from the ingress buffer manager, the ingress header processor processing the packet headers and prepending signature information to the packet headers including information about a destination port to which to send the data packets; and
an ingress traffic manager for scheduling the data packets to be sent by the ingress buffer manager to the destination port indicated by the signature information in the packet headers, wherein if further processing is needed, the data packets are sent back to an input of the ingress buffer manager over a loopback data path.

7. The packet switch of claim 6, wherein if a TTL (time-to-live) of a data packet has expired, the data packet is scheduled to be output on the loopback data path back to the ingress buffer manager for further processing by the ingress header processor.

8. The packet switch of claim 6, wherein if no further processing is needed, the ingress buffer manager sends the data packets to a switch fabric, and wherein the packet switch further comprises:
an egress buffer manager for receiving the data packets from the switch fabric and buffering the data packets;
an egress header processor for receiving the packet headers from the egress buffer manager, the egress header processor processing the packet headers and modifying the signature information in the packet headers to indicate information such as a destination port to which to send the data packets; and
an egress traffic manager for scheduling the data packets to be sent by the egress buffer manger to the destination port indicated by the signature information in the packet headers, wherein if further processing is needed, the data packets are sent back over the loopback path to the ingress buffer manager.

9. A method for processing data packets received at a packet switch comprising:
receiving a data packet into a multiplexer of the packet switch, the data packet received from an incoming interface;
processing the data packet at an ingress processing engine;
determining if further packet processing is required;
providing a loopback data path for the data packet to be reintroduced to an input of the multiplexer if further processing is required; and
iteratively processing layers of the data packet at the ingress processing engine.

10. The method of claim 9, further comprising prepending a signature header to the data packet providing internal routing instructions resulting in the data packet being reintroduced to the input of the multiplexer to be sent to the ingress processing engine for further processing whereupon lower levels of headers in the data packet are processed.

11. The method of claim 9, wherein if determining if no further data packet processing is required, passing the data packet to a switch fabric.

12. The method of claim 9, further comprising:
receiving data packets at the multiplexer from the loopback data path; and
multiplexing the data packets into an ingress pipeline with data packets received from the incoming interface.

13. The method of claim 9, further comprising:
sending the data packet from the ingress processing engine to an egress processing engine;
the egress processing engine modifying the signature header in the data packet to provide internal routing instructions resulting in the data packet being reintroduced to the input of the multiplexer; and
sending the data packet over the loopback data path to the input of the multiplexer.

14. The method of claim 13, wherein the step of the egress processing engine modifying the signature header in the data packet is performed if additional lower levels of headers in the data packet need to be processed.

15. The method of claim 9, wherein the step of determining if further data packet processing is required comprises determining if upper level protocol headers of the data packet need to be removed thus exposing lower level protocol headers for processing.

16. The method of claim 15, wherein the data packet is encapsulated with a TCP header at the Transport Layer to form a TCP packet, then encapsulated with an IP header at the Network Layer to form an IP packet, then encapsulated with one or more MPLS headers to form a MPLS packet, and then encapsulated with an Ethernet header at the Link Layer to form an Ethernet packet, and wherein the method further includes:
processing the data packet at the ingress processing engine by removing the Ethernet header of the data packet;
processing the data packet at the ingress processing engine by removing the MPLS headers of the data packet;
sending the data packet over the loopback data path to the input of the multiplexer;
processing the data packet at the ingress processing engine by examining and modifying the IP header of the data packet; and
sending the data packet to a destination port of the packet switch.

17. A method for processing data packets received at a packet switch comprising:
receiving an IP datagram destined to a set of hosts that form a multicast group;
processing the IP datagram at a processing engine;
sending the IP datagram to a switch fabric to forward the IP datagram to a host of the multicast group;
providing a loopback data path for data to be reintroduced to an input of the processing engine if further processing is required; and
sending a copy of the IP datagram over the loopback data path to the input of the processing engine;
sending the copy of the IP datagram to a switch fabric to forward the copy of the IP datagram to another host of the multicast group; and
iteratively sending copies of the IP datagram over the loopback data path to the input of the processing engine in order to send the copies of the IP datagram to all of the hosts of the multicast group.

18. A method comprising:
receiving a packet including N distinct layers of header information;
a header processing engine processing the packet a first time to process K layers of the header information, wherein the header processing engine is capable of handling in one pass at most K layers of header information; and
processing the remaining (N−K) distinct layers of header information by looping back the packet to an input of the header processing engine [floor(N/K)] times, where K layers of header information is processed during each time.
